(19) United States
(12) Patent Application Publication
(10) Pub. No.: US 2004/0243631 A1
(43) Pub. Date: Dec. 2, 2004

(54) System or method for gathering and utilizing information

(76) Inventors: Andrew S. Walker, Franklin, MI (US); Bruce McLaughlin, Citrus Heights, CA (US); John Lauer, Royal Oak, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/693,664

(22) Filed: Oct. 24, 2003

Related U.S. Application Data
(60) Provisional application No. 60/421,194, filed on Oct. 25, 2002.

(51) Int. Cl. G06F 7/00

(52) U.S. Cl. 707/104.1

(57) ABSTRACT

A system or method (collectively “system”) for gathering and utilizing information. The system can identify, gather, and manage information in an automated fashion without human intervention and in accordance with user-defined processing rules (“rules”). Communications, documents, and other forms of information embodied in a retrievable format (collectively “files”) can be stored in a depository that is accessible by a search tool. The search tool uses a search parameter to identify one or more interesting files amongst all of the files in the depository. Search parameters can be created in accordance with rules relating to particular objectives. For example, in a tax credit embodiment, potential tax credit opportunities can be identified from within the depository. The search parameters can be designed to identify particular activities in accordance with relevant tax laws and regulations. Information contained in the interesting files can be stored in various database records formatted specifically to accomplish the specific objectives of the system.

### RELATED APPLICATIONS

This application claims priority from the provisional patent application titled “SYSTEM OR METHOD FOR GATHERING INFORMATION” (Ser. No. 60/421,194) that was filed on Oct. 25, 2003, the contents of which is hereby incorporated by reference in its entirety.

### BACKGROUND OF THE INVENTION

The invention is a system or method for gathering and utilizing information.

There is an ever increasing demand for information. Technological developments such as computers and the Internet, have only served to increase the demand for information that is created, stored, accessed, and communicated by human beings. Organizations such as government entities, businesses, and non-profit organizations are constantly in the process of creating, capturing, communicating, or storing information. Organizations of all types and sizes spend substantial time, money, and other resources into building vast depositories of information.

The technology of managing information has not kept up with the technology of storing data. The voluminous quantities of stored data, coupled with inadequate search, retrieval, and management mechanisms has resulted in a high-tech version of looking for a needle in a haystack. Organizations, especially large and complex organizations, need better tools for identifying, retrieving, accessing, managing, and utilizing information.

There are numerous examples of how better management of internal information can benefit an organization. Within the field of tax accounting alone, there are many examples of unutilized and underutilized information. One such example is the ability of an organization to identify and utilize research and development expenditures and claim R&D tax credits. Accounting personnel in an organization are unlikely to be aware of all the various activities occurring in research labs, manufacturing plants, and other environments that could be subject to a tax credit or other benefit to the organization. Thus, the inability of an accountant to easily obtain relevant information can result in many lost opportunities for an organization to benefit itself utilizing information already in the possession of the organization. It would be desirable for an automated system to search the depository of an organization in a highly automated way in order to gather and utilize potentially valuable information. It would be desirable for such a system to automatically store and format such information in a form that is in accordance with criteria relating to the potential benefit to the organization. It would be desirable for an organization to make better use information created, communicated, stored, modified, and accessed by people within the organization. It would also be desirable to make effective use of information that is initially captured and stored for different reasons by different personnel.

### SUMMARY OF INVENTION

The invention is a system or method for gathering and utilizing information. An organization's information can be stored in a depository accessible to being searched by a search tool. The search tool can implement a search using a search parameter. The search can be used to identify one or more interesting files within the depository. Useful information can be stored in the database, and the system can be used to automatically generate reports and new files using the information available on the database.

In some embodiments, the depository can include a wide range of information in wide range of different formats, such as e-mails, word processing documents, spreadsheets, and other types of files (collectively “files”).

In some embodiments, the search tool can incorporate a wide range of searching technologies, including artificial intelligence, expert systems, linguistic applications, and other technologies (collectively “searching technologies”).

In some embodiments, the objectives of the organization are used to create criteria, and the system is configured to automatically create search parameters using the criteria.

In some embodiments, the system is used to capture information useful for claiming and/or calculating tax credits. In such embodiments, search parameters are generated by the system in accordance with tax statutes and regulations (“tax criteria”). In a tax credit embodiment, information that was originally captured and stored for research, development, and other technical purposes can then be effectively used for the purposes of obtaining research and development tax credits.

In some embodiments of the system relating to tax credits, the system includes a patent safe harbor component that automatically incorporates processing rules that are based on principles of tax law.

In some embodiments, the objectives of the organization can be to create criteria which are then used by the system to automatically create search parameters.

The present invention will be more fully understood in light of the detailed description of the embodiments in conjunction with the accompany drawings.

### BRIEF DESCRIPTION OF THE DRAWINGS

In the drawings:

FIG. 1 is a block diagram illustrating an example of an environmental view of a system or method (collectively “system”) for gathering and utilizing information.

FIG. 2 is a flow chart illustrating an example of the processing performed that can be performed by the system.

FIG. 3 is a process flow diagram illustrating an example of the system being utilized to generate reports relating to tax credit information.

### DETAILED DESCRIPTION OF THE EMBODIMENTS

This invention relates generally to a method or system for automating the collection, management, and analysis of data relating to qualifying research activities. More particularly, this invention relates to a method, system, or apparatus (collectively “system”) that manages and utilizes a repository or depository of information for the purpose of enabling easy access, manipulation, and evaluation of data contained in different types of digital and other storage media. Through the normal course of operations, an organization can collect and store information in the depository in the form of various files, such as e-mails, word processing documents, spreadsheets, web sites, scanned paper documents, database records, and other formats (collectively “files”). A multitude of data items can be collected and stored in the depository. Data items can be automatically searched for relevance and organized according to user defined or pre-defined categories and search parameters based on criteria derived from the objectives of the organization. Reports can be automatically generated enabling the analysis and review of organized data to identify relationships indicating: (1) commonalities between various research activities; and (2) other business synergies of potential economic advantage. At that point other documents including financial, vendor, and employee databases are searched to identify relevancies. Additional knowledge can be added to the reports items in terms of explanatory narrative, employee lists, cost sheets, tax credit calculations, conclusions, synergetic relationships, and business opportunities. The system can retain the content and results of a search such that it is only necessary to perform a search once.

I. Environmental View and Intorduction of Elements

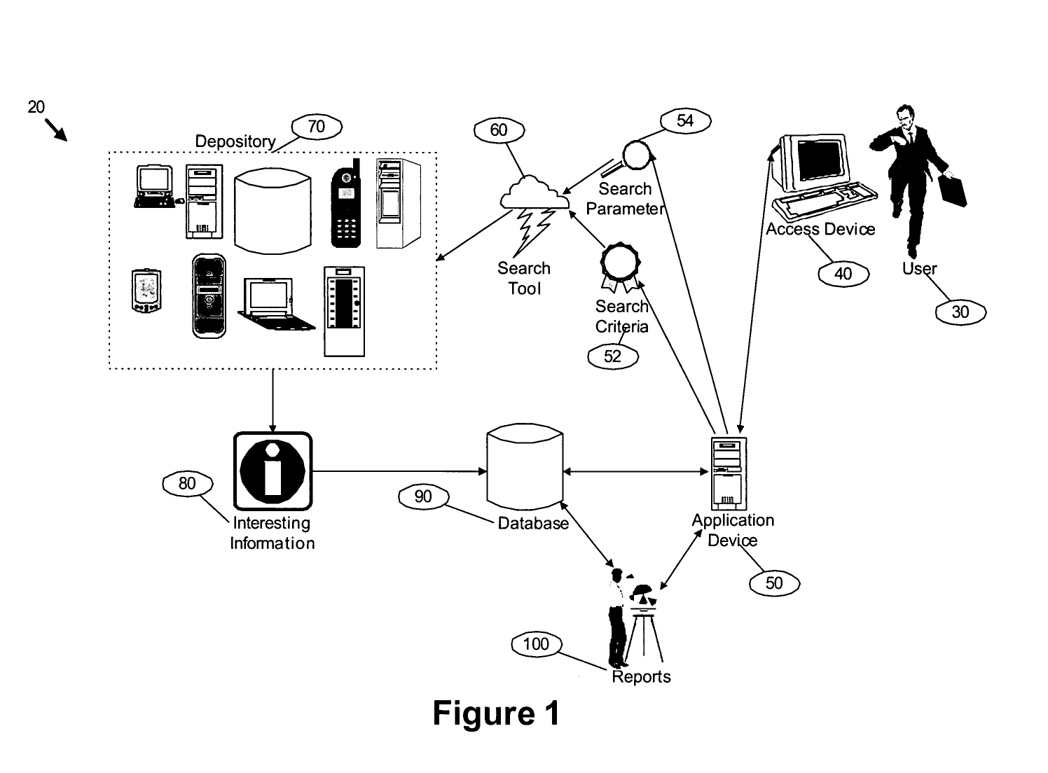

FIG. 1 is a block diagram illustrating an example of an environmental view of a system or method (collectively “system”) 20 for gathering and utilizing information.

A. User

The system 20 is highly flexible, and can incorporate a high degree of automation. A user 30 of the system 20 can be a human being, or some form of man-made system, such as an artificial intelligence unit, an expert system, a robot, or any other type of device capable of interacting with the system 20. Multiple users 30 can interact with the system 20. Users 30 can be responsible for incorporating the objectives of an organization into criteria used to help create and implement search parameters.

B. Access Device

The access device 40 is potentially any device capable of allowing a user 30 to interact with the system 20. Desk top computers, lap top computers, work stations, cell phones, web servers, personal digital assistants (PDAs), mainframe computers, dumb terminals, and other devices can be used as access devices 40 with regards to the system 20. In a preferred embodiment, the access device 40 is a computation device with a web browser capable of connecting to the Internet. In some embodiments, the access device 40 may itself be a user 30 of the system 20.

C. Application Device and Application

An application device 50 is any device capable of housing the programming logic implemented by the system 20. Users 30 interact with the application device 50 through the access device 40. The application device 50 can be a wide range of different computational devices such as desktop computers, work stations, mainframe computers, laptop computers, personal digital assistants (PDAs).

The programming logic used to support the functionality of the system 20 can be referred to as an analysis application. In contrast to the various applications (“source applications”) that add data, communications, and other files (collectively “files”) to the depository 70, the purpose and functionality of the analysis system is to seek out information within the depository 70, and populate a database 90 of interesting information 80 in the form of goal-specific records. In some alternative embodiments, the analysis application may also function as a source application in certain respects.

In a preferred embodiment, the data contained in the goal specific records are not limited to the interesting information 80 contained in the depository 70. The programming logic of the system 20, in the form of various processing rules, can reformat and even transform the interesting information 80 into a more useful form. For example, in an R&D tax credit embodiment of the system 20, interesting information 80 contained in the interesting files of the depository 70 can be categorized using the processing rules or “intelligence” within the analysis application. The ability to place specific pieces of information into a hierarchy of relevant information categories can be a highly value-added function of the system 20.

In an embodiment of the system 20 where the goals of the system 20 are to obtain information for tax purposes, the application can be referred to as a tax analysis application. In embodiments of the system 20 where the goals of the system 20 are to obtain information relating to R&D tax credits, the application can be referred to as an R&D tax credit analysis application.

D. Search Parameter and Search Criteria/Processing Rules

A search parameter 54 is the mechanism by which a search tool 60 performs a search. For example, if the system 20 is to identify all instances where a machine was improved, the words “machine” and “improve” may be included as search parameters 54. Search criteria 52 relates to information and embedded intelligence between the general objectives of the user 30 and the search parameter 54 to be performed by the search tool 60. The search criteria can also be referred to as “processing rules.” Examples of search criteria can include the four requirements for obtaining a research and development tax credit, as discussed below. Processing rules or search criteria 52 can be entered into the system 20 in a variety of different ways, including by user input through a keyboard or other device, or through the importing of various tables or other files.

E. Search Tool

A search tool 60 is any mechanism by which the system 20 performs a search. The search tool 60 can incorporate functionality from an artificial intelligence component, an expert system component, a linguistic analysis component, a predictive modeling component, a neural network component, or other form of intelligence technology (collectively “intelligence technology”). Inktomi, iSleuthhound Technologies, MBWWare.com, and other companies are vendors of prior art search tools that can be incorporated into the system. A wide variety of different intelligence technologies can be incorporated into the system 20.

F. Depository

A depository 70 is a collection of information upon which a search can be performed by the system 20. The depository 70 of an organization can consist of a wide variety of different devices, such as servers (including web servers, e-mail servers, application servers, and document servers), databases (including relational databases, object-oriented databases, and binary databases), and other devices capable of connecting to a network, such as laptop computers, desktop computers, PDAs, cell phones, and other devices.

Information in a depository is stored and accessed in the form of a file, such as an e-mail, a word processing document, a spreadsheet, or some other form of embodied information (collectively “files”).

G. Interesting Files and Interesting Information

Interesting information 80 is information in the depository 70 that is identified as interesting by the system 20 with respect to a search performed by the search tool 60. Interesting files are files that contain interesting information.

H. Database

A database 80 can be used to store interesting information 80, interesting files, or new files created with interesting information. A wide variety of different data storage technologies can incorporated into the system 20, including relational databases, object-oriented databases, binary databases, arrays and other data structures, flat files, and other data storage technologies (collectively “databases”) 90.

I. Reports

A reports component 100 can be used to generate reports and other forms of analysis from the information and files saved on the database 80. As is indicated on FIG. 1, there are two-way arrows between the database 80, the reports component 100, the application device 50, and the access device 40. In preferred embodiments of the system 20, searches and report generating are performed in an iterative fashion building upon prior results and analysis.

II. High-Level Process Flow

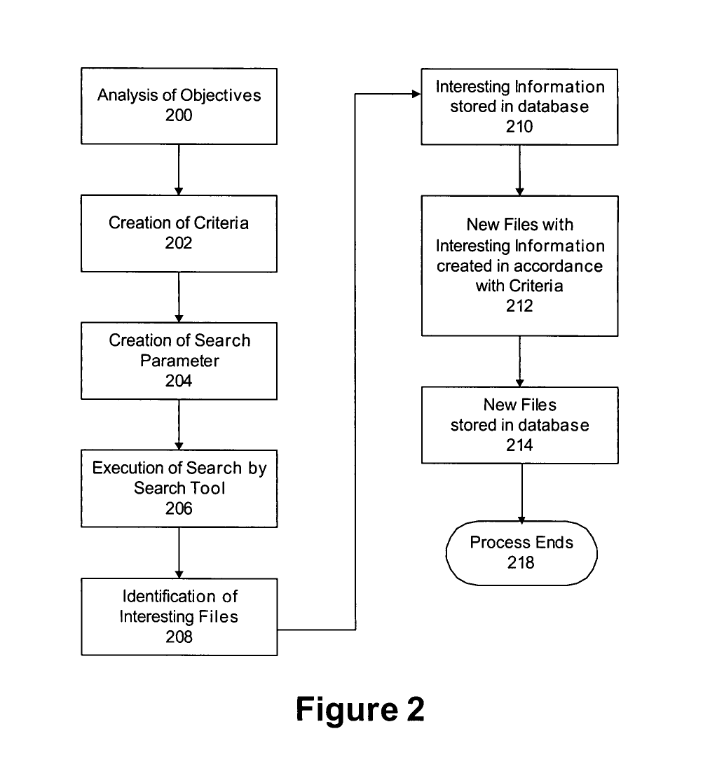

FIG. 2 is a flow chart illustrating an example of a high level process flow of the system 20.

At 200 an analysis of objectives is performed. This is a high-level stage of issue identification. For example, at 200, a user 30 could determine that his or her organization needs to make greater use of the research and development tax credit (R&D tax credit) as described below.

At 202, criteria relating to the objectives at 200 are created. For example, if the objective is greater use of the R&D tax credit, the criteria needed to qualify for such a credit needs to be incorporated into the system 20.

At 204, specific search parameters are created. This process can preferably incorporate the criteria created at 202.

At 206, a search tool is invoked to perform a search using the search criteria created at 204.

At 208, interesting files are identified by the system 20.

At 210, interesting information is stored in the database 90.

At 212, new files with interesting information are created in accordance with the criteria. The system 20 can incorporate a wide range of post-search analysis processes during this step.

At 214, the newly created files can be stored in the database 90. These files exist solely for the purposes of satisfying the criteria identified at 202 and the objectives identified at 200.

At 218, the process ends. It should be noted that this process can be highly iterative, with search results and analysis serving as the basis for future searches and analysis.

III. Accounting Embodiment

The system 20 can be configured for a wide variety of uses. One category of embodiments can be referred to as accounting embodiments. The system 20 can be an effective tool for capturing data (1) not generally accessible by accountants in the prior art; but (2) useful to accountants.

In addition to traditional financial documents used by accountants and others to identify qualified research activities (“QRAs”), qualified research expenses (“QREs”) and other activities (collectively “accounting activities”), the system 20 can use information extraction systems (“IES”) and other search technologies to create a unique database of documents (“Database” 80) previously not used in the R&D (research and development) identification, qualification and documentation process.

Once the documents are identified and put into the database 80, a searcher can use the software in the system 20 to index and sort them so they can be reviewed, compared to the requirements of IRS regulations, and subjected to other screening processes. If appropriate, the documents can be printed or stored in a form which can be used to support a company's claim for credits, including for audit purposes.

Organizations are known to use word-searching software to manipulate documents already known to be related to QREs. These documents are usually part of the company's financial documents, often designated as the R&D “cost center.” The system can incorporate, in various combinations, existing software, neural language software, elements of artificial neural networks, “sniffing” software, and other IES techniques to search the database 80 and, thereby, constitutes a unique method for identifying, qualifying and documenting QRAs/QREs. These documents reside primarily on a company's network servers, but can be at any searchable location.

The documents which make up the database 80 include, without limitation, combinations of emails, calendars, documents containing predetermined key words, patents, patent applications, and other documents not previously associated (individually or collectively), which identify, evaluate and document QRAs/QREs. The keywords are, without limitation, words, phrases and other indicators that correlate in some way to QRAs/QREs, including names of technologies, “plant floor” documents, geographic locations, names of company's processes, events, products, company employee names, contractor and agent names (and their relevant keywords), and other QRA/QRE related designations.

By searching the database, an organization can identify, without limitation, more QRAs/QREs, and leads to QRAs/QREs, which are:

(a) at locations too remote to cost-effectively locate in a manual fashion;

(b) too geographically dispersed to be otherwise identified;

(c) not cost-effectively retrievable by personal interviews or other manual searches;

(d) able to be documented without further (or limited) confirmation;

(e) at remote, but searchable, locations outside the company (such as at a contractor's, agent's, supplier's, consortium member's, or consultant's location);

(f) correlated to the company's patent portfolio or third party's patent portfolio (e.g., a supplier's portfolio where the company is taking the risk and is entitled to the credit); or

(g) in otherwise searchable form.

The system 20 can be automatically enhanced because the application software used by the system 20 can become more effective as its searching capacity “learns” about an organization by repetition.

The system 20, including the application software, generates the following efficiencies:

(a) Organizations identify more possible documents and information related to QRAs/QREs;

(b) Organizations can automatically index, sort and organize the documents found so they can be efficiently reviewed and the evaluation requires less person-hours;

(c) These documents and other sources of information can be converted into documentation which supports claims for QREs;

(d) Other documents and information can be automatically correlated to the documents, and claimed QREs;

(e) Because organizations find more QRAs/QREs, using fewer person-hours, it is less costly on a cost/credit basis.

The searcher can manipulate the enhanced pool of documents and information (collectively “new files”) by executing additional searches, modifying the criteria used to generate the search parameters, or by other follow-up activities.

A person reviewing the work product of the searcher would be able to more effectively do his or her job of preparing the review because all relevant information is more readily accessible.

A person preparing for an audit can use the documentation found and organized by the searcher advantageously to prepare documentation to substantiate any conclusions or calculations being audited.

IV. R&D Tax Embodiments

The system 20 can be used in a wide variety of different settings to accomplish a wide variety of different goals. One category of system 20 embodiments can be referred to as R&D tax embodiments.

Prior art techniques at identifying R&D tax credits (RTC) are particularly lacking when it comes to qualified research activities that occur in the manufacturing environment, particularly those occurring on the “plant floor.” A substantial amount of documentation is generated in the normal course of business for the purpose of measuring and managing these manufacturing activities and other activities that are not commonly identified as research activities. Such documentation is not, however, intended to identify, track, or manage R&D activities. Therefore, a significant amount of qualified research activities cannot be identified unless a means and method is devised to search this vast quantity of unhomogenized data. Use of the system 20 can facilitate the identification of such activities. The system 20 can also collect and analyze data in an automated fashion in accordance with the criteria for qualifying for an R&D tax credit.

The system 20 can incorporate the functionality of an information extraction system (IES)—a system 20 to extract specific kinds of information from a source document, thereby producing a summary of the original text according to a pre-defined specification of the information to be searched. The system 20 can also incorporate the functionality of an artificial neural network (ANN)—an information processing system composed of interconnected processing elements that can be trained to learn relationships in the data that it is given. The functionality of artificial intelligence (AI) components can also be incorporated into the system 20. AI technology, as it currently exists, functions best with a high degree of standardization and repetition. Thus, use of AI technology may require well designed criteria to make the process sufficiently standardized and repetitive.

A. Prior Art Techniques

In the prior art, RTC has been categorized primarily as an accounting function and the legal analysis has been routinely backwatered. Resulting from the emphasis on accounting principles, the process to identify qualified research activities (QRAs) probably begins with a search through financial documents. This method identifies the qualified research expenses (QRES) and then the RTC team creates descriptive documentation to support them. The most effective method, however, is exactly the reverse. The team should first identify all QRAs and then search the financial records to determine the expenses.

Prior art methods typically require the accountants to make contact with a plant before collecting any documentation. Technical information was gathered through labor-intensive personal (or telephone) interviews by asking the interviewees generic questions based on the RTC, e.g., “Did you improve or develop anything last year that helped you learn new technological information?”

At the very least this had two major flaws relating to the quality and quantity of information. First, it relied upon the re-collective ability of a production person who was frequently overloaded with urgent matters in the present. They were hard pressed to recall significant details concerning activities that happened in the past. Second, it largely placed the burden of defining what activities were qualified on the interviewee. Defining QRA, however, is both a technical/legal determination and not generally within the expertise of the interviewee. As a result, the full extent and scope of many qualified activities were not identified. And most likely, some entire activities were not even identified at all.

Another shortfall of many traditional RTC approaches is the concentration on more formal research activities. Some software products are available for the tracking of R&D activities in real time. Their emphasis is on providing a web-enabled real time environment for researchers to manage scientific and engineering projects. They have the capability to capture relevant data as it occurs. However, these contemporaneous project management programs have several obvious shortcomings in regard to maximizing QRA identification. The first is the determination of which projects are tracked and what criteria are used to make the selection. Due to the labor intensity of using the software in real time, only certain projects will be chosen for tracking. Will the decision utilize technical, legal, and financial criteria? Will some projects be too small to track cost effectively? Second, a significant amount of ORA occurs on the plant floor in the normal course of manufacturing activities. They are not pre-identified as ORA and may not follow classical research processes. Some QRA may be small activities that are subsets within very large projects, which are not experimental when taken as a whole. Other QRA may occur in response to manufacturing problems, which are subsequently resolved by manufacturing personnel. R&D management software will not capture these types of activities. The only documentation that identifies these are the industrial documents (ID) generated in the normal course and scope of daily business.

B. Improvements of the System over the Prior Art

A more effective method to identify QRAs is through this industrial documentation that was generated contemporaneously, but not with the intended purpose of tracking research activities. These include: monthly status reports; trial proposals, plans, and reports; spread sheets; technical papers written for publication or training; newsletters and other public communications; project financial justification reports; machine reports with costs or information to track the costs; email messages describing activities, questions, conclusions, etc.; best practices guides; employee lists; externally generated documents by vendors, customers, consultants, labs, or contractors; testing results; machinery descriptions and overviews; and, technical documents received from literature searches, etc. Within these documents resides text with direct descriptions of QRAs and text from which QRAs can be inferred. Therefore, this text that includes many specifics such as dates, times, supplies, and personnel serves to identify virtually all QRAs occurring in the plant environment. Then it is merely an administrative task to match expenses to these activities.

It behooves the RTC team to collect as much ID as possible because as greater amounts of documentation are collected, greater amounts of QRAs are identified, and that naturally results in greater amounts of QREs. But then an entirely different problem presents itself, i.e., data overload. The ID includes an enormous amount of both quantitative data (charts, tables) and qualitative data (narrative). As a result, the RTC team can often become overloaded with information that is potentially extremely useful but, due to lack of time, cannot be properly evaluated.

One way to solve this problem is to produce a short summary (template) of the documentation according to specific criteria, eliminating the information that is not considered relevant. The availability of these summaries, rather than the full documents, can lead to a marked reduction of time needed by the technically skilled person (TSP) to evaluate the information. This process of summarizing the documents is called information extraction and belongs to the field of Natural Language Processing (NPL). As discussed above, important information 80 is extracted data, while important files is the original format of the data.

For large collections of documents, the identification of the information needed by a human can become a difficult and long task and, therefore, automatic processing using information extraction systems (IES) can be extremely useful. Most prior art IES have been developed and tested within government agencies or scientific environments. This has lead the way to very specialized systems able to work only in restricted situations and domains. Furthermore, the ID comprises an extremely wide domain including different kinds of information: technical, financial, safety, etc. Therefore, the identification of a unique template able to summarize all the possible QRAs is extremely difficult, if not impossible. One solution to this problem is to design multiple templates. This may also be achieved by (a) intense work on the front end to improve the quality and uniformity of the information being collected on a real time basis or (b) improving the IES software functionality, which will get more sophisticated as it becomes more familiar, for example, with a company's systems and terminology (See ANN below).

These templates should be based on the identification of specific technical activities involving uncertainty (TUA). A TUA is here defined as an activity having uncertainty at its outset as to the outcome of the activity. These might be identified by key words connoting questions, conclusions, results, alternatives, trials, successes, or failures. A specific template could be associated with each TUA because identifying these activities represents the main information that the RTC team may want to extract from the source document. It also represents an effective partitioning of the broad documented domain.

Qualitative data comprises the major useful component of all data collected. Qualitative data, however, is much more difficult to process than quantitative and very little progress has been done in the processing of qualitative information. This is usually left to the human interface. For one reason, humans have the ability to infer information from text that does not include a defined set of key words. Therefore, current development of qualitative tools is concerned mostly with reducing, summarizing, or partitioning the documents according to specific criteria, rather than inferring decisions from them, i.e., in this application, preparing interview questions.

Use of the IES in this way, in addition to more efficiently identifying and documenting targeted QRAs, can also make it feasible to collect information which was never collected before because (a) it was too geographically remote or (b) was too small to be retrieved economically, or (c) was too disbursed within the company to be collected and organized into a useful form. In this way the information and material can be salvaged and made valuable. This is where NPL comes into play. The emphasis of NPL is to provide the human with information which is the summary of the relevant data, rather than an output to suggest an action or make a conclusion. The “trend” is captured and identified, but the interpretation of the final information is left to the TSP. The NPL tool can extract information concerning the underlying activity.

The main task of general support tools based on NPL is therefore to help the TSP overcome the actual qualitative data overload simplifying and reducing the amount of qualitative information that are needed to prepare for directed and specific interviews. This improves the RTC interview process in a variety of ways: (1) interviewers are more prepared to ask pertinent and specific questions; (2) the extracts may be used to refresh the memory of interviewees; (3) most data collection preceded the interview so less time is spent on identifying and collecting additional documentation; and (4) interviews may be more brief and concise. At the current time, there are no known IES able to process a large amount of diverse industrial documentation and produce sensible and useful results for QRA identification.

The IES can be organized to collect information and identify materials which match a predetermined set the IRS legal requirements and support documentation criteria. The database holding the product of the IES can be organized so that the information and material can be formatted in a standard way which, when printed, could comprise part or all of the materials which have to be made available to the IRS. This would reduce the review by a technical person without sacrificing quality control. In fact, this IES module automatically generates and updates five descriptive, chronologically correct “working tools” (WT) using only 2 clicks: (1) project database; (2) preliminary write-up; (3) comprehensive chronology; (4) project timeline; and (5) project cost sheet. The IES module enables lower knowledge personnel to review virtually all documentation. The personnel produce the 5 WT's following a very broad standard that captures all potential QRA (signal) but also excises a substantial amount of irrelevant data (noise). It is reasonable to expect that the original documentation pool could include as much as 98% noise. Therefore, the higher knowledge personnel need only review 2% (in this example) as much data as they would using traditional methods. Their labor is reserved primarily for higher knowledge activities, i.e., interviewing, editing, and technical/legal analysis. Overall, the RTC process may be reduced from one requiring 90% high knowledge labor to one requiring significantly less than 50%.

Additional functions of the IES incorporate characteristics of an artificial neural network (ANN). As the IES identifies new activities, it will “learn” new search terms and concepts in similar fashion to an ANN. It will use these new terms to search all ID, even the documents that have already been searched using earlier sets of terms. Automated searching will identify similarities between diverse documents that enables the tracking of QRA crossing geographical boundaries. For example, some QRA is conducted at one plant and then the product is shipped to another plant for further trial evaluation. The trial may not end until it has been field tested many weeks later. Some trial products are tracked extensively at the producing plant and then sent to converting plants for further testing. Documentation specifically describing the trial are often more difficult to find at the converting plants. The connections may be no more than dates or roll numbers. Automated searches make finding this connection possible.

It should be part of the IES that it “improve” each quarter or year, to meet set goals, until a projected optimum amount of information and material is identified and documented at the lowest cost (perhaps measured as dollars spent/dollar saved in taxes.)

C. Patent Safe Harbor Component

The system 20 can enable an organization to fully utilize the patent safe harbor provision of 26 CFR § 1.41-4(a)(3)(iii). The system 20 can extract relevant information from the company's patent documents including key words and concepts. These are used as new search terms for reviewing all ID and identifying activities related to the patentable subject matter. These newly identified activities will achieve a higher standard of substantiation since the issuance of a patent provides conclusive evidence that a company, through these activities, has discovered information that is technological in nature and is intended to eliminate uncertainty concerning the development or improvement of a business component.

There are four basic tests that must be met with respect to a RTC under U.S. law: (1) Proper purpose; (2) Discovery (eliminating uncertainty); (3) Technological nature; and (4) Experimental process.

The proper purpose prong is virtually a given for all activities. The technological nature element is similarly simple to meet for the activities we qualify. The two prongs that are the most difficult to find are the discovery and experimental process elements. In a very real way for manufacturing companies, each of these elements portends the other. In other words, a situation involving uncertainty is generally resolved through experimental means. Likewise, if a manufacturing plant allocates precious time, manpower, and materials to an experiment, it was only because the personnel were uncertain about the capability, method, or appropriate design.

A search to identify OR entails reviewing documentation to finding indicators of either uncertainty or experimentation. When the system 20 effectively identifies one, the system 20 typically has a high success rate working backwards to establish the remaining three elements.

Deduction 1: If we can identify more activities of either element, we will qualify more activities.

IDEA 1: The patent safe harbor provision states that an issued patent is conclusive evidence of the discovery element. If Deduction 1 is correct for manufacturing companies, then “exploiting” the PSH will provide a significant financial benefit to a company with a growing patent portfolio. Our software should extract information from patents and use it to search through industrial documentation and identify all connections.

IDEA 2: The PSH provision is conclusive evidence of the discovery element. Apply the experimental use doctrine elements to all connections identified in IDEA 1. Use the “totality of the circumstances” to establish and legally support that the business component was still undergoing experimentation and was not functionally or economically viable. This provides convincing evidence and a proper legal argument to overcome the commercial production exclusion.

Cognizant of the patent safe harbor rule, the system 20 can be configured to automatically search the depository 80 to look for elements included in patents issued to the organization.

D. Syst m Functionality

As stated above, a more effective method to identify QRAs is through the ID. Examples of industrial documentation includes: monthly status reports; trial proposals, plans, and reports; spread sheets; technical papers written for publication or training; newsletters and other public communications; project financial justification reports; machine reports with costs or information to track the costs; email messages describing activities, questions, conclusions, etc.; best practices guides; employee lists; externally generated documents by vendors, customers, consultants, labs, or contractors; testing results; machinery descriptions and overviews; and, technical documents received from literature searches, etc. Within these documents resides text with direct descriptions of QRAs and text from which QRAs can be inferred. It generally includes many specifics such as dates, times, supplies, and the names of company personnel. This serves to identify virtually all ORAs occurring in the plant environment and then it is merely an administrative task to match expenses to these activities.

It behooves the RTC team to collect as much ID as possible because as greater amounts of documentation are collected, greater amounts of QRAs are identified, and that naturally results in greater amounts of QREs. But at this point, an entirely different problem presents itself, i.e., data overload. The ID includes an enormous amount of both quantitative data (charts, tables) and qualitative data (narrative). As a result, the RTC team becomes overloaded with information that is potentially extremely useful but, due to lack of time, cannot be properly evaluated. One solution is to produce a short summary (template) of the documentation according to specific criteria, eliminating the information that is irrelevant. This process of summarizing the documents is called information extraction and belongs to the field of Natural Language Processing (NPL). Reviewing these summaries, rather than the full documents, leads to a marked reduction of time needed by the technically skilled person (TSP) to evaluate the information.

For large collections of documents, the identification of the information needed by a human becomes a difficult and long task and, therefore, automatic processing using information extraction systems (IES) can be extremely useful. The ID comprises an extremely wide domain including different kinds of information: technical, financial, safety, etc. Therefore, the identification of a unique template able to summarize all the possible QRAs is a technologically formidable task. One alternative solution is to design multiple templates. This may also be achieved by (a) intense work on the front end to improve the quality and uniformity of the information being collected on a real time basis or (b) improving the IES software functionality, which will get more sophisticated as it becomes more familiar, for example, with a company's systems and terminology (See ANN below).

These templates should be based on the identification of specific technical activities involving uncertainty (TUA). For our purposes, a TUA is defined as an activity having technological uncertainty at its outset as to the outcome of the activity. These might be identified by key words connoting questions, conclusions, results, alternatives, trials, successes, or failures. A specific template could be associated with each TUA because identifying these activities represents the main information that the RTC team may want to extract from the source document. It also represents an effective partitioning of the broad documented domain.

Qualitative data comprises the major useful component of all data collected. Qualitative data, however, is much more difficult to process than quantitative information. This is a very difficult task and has frequently been left to the human interface. For one reason, humans have the ability to infer information from text that does not include a defined set of key words. Therefore, current development of qualitative tools is concerned mostly with reducing, summarizing, or partitioning the documents according to specific criteria, rather than inferring decisions from them like preparing interview questions, for instance.

Use of the IES in this way, in addition to more efficiently identifying and documenting targeted QRA, can also make it feasible to collect information which was never collected before because it was: (1) too geographically remote; (2) too small to be retrieved economically; or (3) too disbursed within the company to be collected and organized into a useful form. By using IES techniques the information and material can be salvaged and made valuable. This is where NPL comes into play. The emphasis of NPL is to provide the human with information, which is the summary of the relevant data, rather than an output to suggest an action or make a conclusion. The “trend” is captured and identified, but the interpretation of the final information is left to the TSP.

The main task of the NPL-based working tools is, therefore, to help the TSP overcome the actual qualitative data overload by simplifying and reducing the amount of qualitative information needed to prepare for directed and specific interviews. This improves the RTC interview process in a variety of ways: (1) interviewers are more prepared to ask pertinent and specific questions; (2) the extracts may be used to refresh the memory of interviewees; (3) the vast majority of data collection precedes the interview so less time is spent on identifying and collecting additional documentation; and (4) interviews may be more brief and concise. At the current time, there are no known IES able to process a large amount of diverse industrial documentation and produce sensible and useful results for QRA identification.

The IES can be organized to collect information and identify materials, which match a predetermined set of IRS legal requirements and support documentation criteria. The IES database can be organized so that the information and material is formatted in a standard way which, when printed, could comprise part or all of the materials which have to be made available to the IRS. This would reduce the reviewing requirement by a technical person, without sacrificing quality control. In fact, this IES module will automatically generate and update six descriptive “working tools” (WT⁶) using only 2 clicks: (1) company database; (2) preliminary write-up; (3) comprehensive chronological repository; (4) facility timeline; (5) activity cost sheet; and (6) a final write-up

The IES module enables low-level technical knowledge (LLT) personnel to review virtually all documentation. The personnel produce the WT⁶s using a very broad standard that captures all potential QRA (signal) but also excises a substantial amount of irrelevant data (noise). It is reasonable to expect that the original documentation pool could include as much as 98% noise. Therefore, the higher knowledge personnel need only review 2% (in this example) as much data as they would using traditional methods. Their labor is reserved primarily for higher knowledge activities, i.e., interviewing, editing, and technicavlegal analysis. Overall, the RTC process may be reduced from one requiring 90% high knowledge labor to one requiring significantly less than 50%.

Additional functions of the IES incorporate characteristics of an artificial neural network (ANN). As the IES identifies new activities, it “learns” new search terms and concepts. It will use these new terms to search all ID, even the documents that have already been searched using earlier sets of terms. Automated searching will identify similarities between diverse documents that enables the tracking of QRA crossing geographical boundaries. For example, some QRA is conducted at one plant and then the manufactured product is shipped to another plant for further trial evaluation. The trial may not end until it has been field tested many weeks later. Some trial products are tracked extensively at the manufacturing plant and then sent to converting plants for further testing. Documentation specifically describing the trial are often more difficult to find at the converting plants. The connections may be no more than dates or roll numbers. Automated searches make finding this connection possible.

It is a normal function for the IES to “improve” each quarter or year as it learns more about the subject company. The IES continues to set new goals for information capture until a projected optimum amount of information and material is identified and documented at the lowest cost (measured as dollars spent/dollar saved in taxes).

An overview of improvements includes: (1) as compared to existing methods, increases the quantity of documents that can be reviewed; (2) final write-ups are created from primary source documents, thereby improving the quality of documentation that is retained for the purposes of complying with IRS record keeping requirements; (3) as compared to existing methods, enables document collection that is less labor intensive for the collecting entity; (4) digital data collection is minimally intrusive and substantially less intrusive than existing methods; (5) the information extraction system (IES) module automatically generates and updates six descriptive, chronologically correct “working tools” (WT) using only 2 clicks; (6) the manual IES module enables lower knowledge personnel to review virtually all documentation; (7) enables improved identification of trial start/stop times to more accurately distinguish qualified trial activities from unqualified “commercial production” activities; (8) enables more extensive identification of named sources of qualified expenses including: employees, contractors, consultants, vendors, supplies, and consumables; (9) automated searching will identify similarities between diverse documents that enables the tracking of trials crossing geographical boundaries; (10) improves the R&E interview process in a variety of ways because interviewers are more prepared to ask pertinent and specific questions by virtue of the WT; (11) WT may be used to refresh the memory of interviewees; (12) most data collection preceded the interview so less time is spent on identifying and collecting additional documentation; (13) interviews may be more brief and concise; and (14) eliminates the need for hand written note taking by enabling the interviewer to easily add annotated notes to the preliminary write-ups during the interview using only 1 click.

E Process Flow

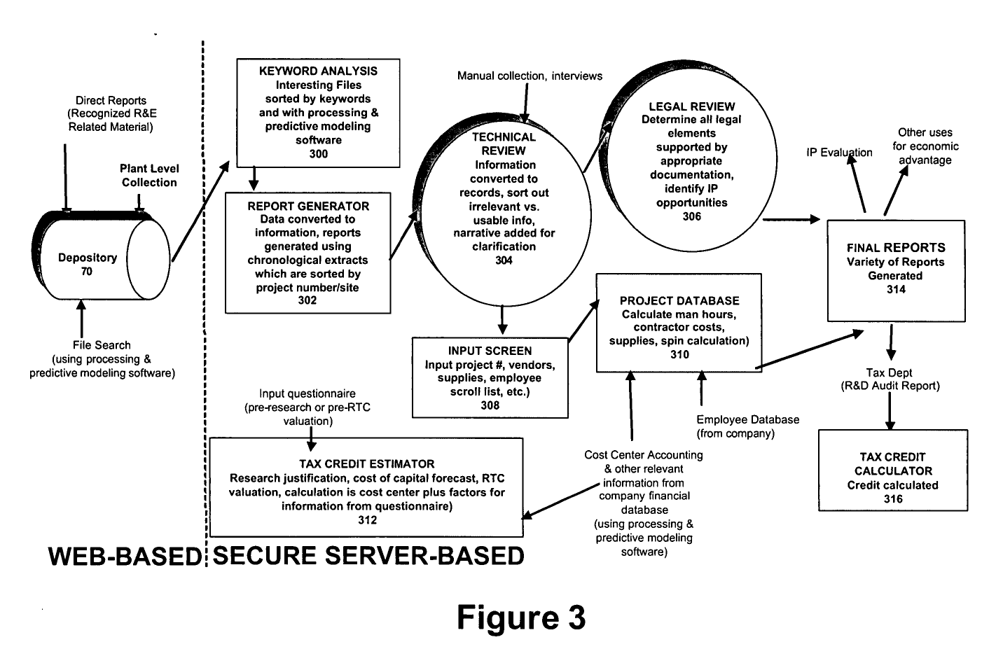

FIG. 3 is a flow chart of a R&D tax credit embodiment of the system 20. The following Table 1 explains the processing performed in FIG. 3.

TABLE 1

| Name | Data collection/input | | Manual activity | Software activity |
|---|---|---|---|---|
| Primary | All industrial documentation | 1 | Input | Stores documentation in |
| data | (ID) that potentially contains | | | a searchable depository. |
| collection | technologically relevant | | | |
| | materials including: monthly | | | |
| | production reports, trial | | | |
| | reports, emails, graphs, and | | | |
| | vendor reports, etc. | | | |
| | Employee database, all write- | 2 | Input | |
| | ups from prior years, and | | | |
| | facility spreadsheet from prior | | | |
| | year. | | | |
| | Engineering accounting and | 3 | Calculate | |
| | project information and spin | | engineering and | |
| | cost data. | | spin data. | |
| | | | Arrange in format | |
| | | | for easy input, | |
| | | | e.g., .xls format to | |
| | | | import into | |
| | | | database. Input. | |
| | | 4 | | Program creates WT1 - |
| | | | | project database with |
| | | | | project numbers as rows |
| | | | | and columns including: |
| | | | | plant, description, |
| | | | | department, contact |
| | | | | person, employees, |
| | | | | costs, title, etc. |
| | | | | (expandable rows?) |
| | | 5 | | Program creates write- |
| | | | | up template with a |
| | | | | generic heading, four |
| | | | | RTC elements, and |
| | | | | footnotes using data |
| | | | | from spreadsheet. |
| 1^{st} Level | | 6 | IES module operated by | Run IES module (e.g. |
| Review - | | | administrative level person. | search tool 60). |
| computer | | 7 | | Program uses Natural |
| | | | | Language Processing to |
| | | | | identify documents |
| | | | | containing reference to |
| | | | | technical activities |
| | | | | involving uncertainty |
| | | | | (TUA). |
| | | 8 | | Program creates WT2 - |
| | | | | The program automatically |
| | | | | extracts useful information |
| | | | | and stores in a format |
| | | | | easily accessible and |
| | | | | readable by humans. This |
| | | | | is a comprehensive |
| | | | | chronological document, |
| | | | | segregated by department, |
| | | | | and annotated with |
| | | | | footnotes indicating source. |
| | | 9 | | Program acts as an |
| | | | | artificial neural network. It |
| | | | | “learns” new criteria as it |
| | | | | searches and repeats the |
| | | | | search to identify additional |
| | | | | information. It may learn |
| | | | | new project titles, |
| | | | | employee or contractor |
| | | | | names, technical terms, |
| | | | | and the like. |
| 2^{nd} Level | | 10 | Perform preliminary technical | Manual information |
| Review - | | | review using the manual | extraction module (“slice & |
| human | | | information extraction function. | dice”) function. |
| | | 11 | Review WT2 comprehensive | Program creates WT3 - |
| | | | chronological repository | Preliminary write-ups are |
| | | | and extract relevant info, | automatically generated |
| | | | tables, graphs, etc. | with proper headings and |
| | | | | chronologically arranged |
| | | | | narrative excerpts. |
| | | 12 | The standard is very broad, | Program creates WT4 - |
| | | | therefore, a low level but | Chronological timeline for |
| | | | technically trained person may | projects at a facility. |
| | | | perform this review. | |
| | | 13 | | Program creates WT5 - |
| | | | | Activity cost sheet. |
| | | 14 | | WT1 database is |
| | | | | automatically updated. |
| Oral | | 15 | Uses WT2 spreadsheet, WT3 | Interviews |
| interviews | | | preliminary write-ups, and | conducted with program |
| | | | WT4 timeline to guide | running on laptop using |
| | | | interview process. This | “Interview pop-up menu” |
| | | | activity is performed by a | (see description). |
| | | | technically skilled person | Concentration is employee |
| | | | (TSP). | time and information not |
| | | 16 | Identify employee | included in raw data. |
| | | | names, man-hours, vendors, | |
| | | | contractors, supplies used, | |
| | | | and additional technological | |
| | | | information | |
| | | 17 | Cost data is collected in typical | WT1, 3, 4, and 5 are |
| | | | fashion but input using the | automatically updated. |
| | | | “Interview menu.” Most data | |
| | | | should have been input during | |
| | | | step “1.” | |
| Secondary | | 18 | Facility personnel click and | |
| data | | | drag all electronic documents | |
| collection | | | into folders on shared directory | |
| | | | of local network. Burn CD. | |
| | | 19 | Collect cost data in the form of | |
| | | | accounting reports, work | |
| | | | orders, AFEs, invoices | |
| | | 20 | Input | WT1 through 5 are |
| | | | | automatically updated. |
| Technical | | 21 | Read secondary data, cut and | WT1 through 5 are |
| review | | | paste to appropriate | automatically updated. |
| | | | preliminary write-up | |
| | | 22 | High-level technical review for | Program creates WT6 - |
| | | | content to excise improper | Final write-up. |
| | | | language or activities, proof | |
| | | | grammar, spelling, etc. and | |
| | | | produce final draft. | |
| | | 23 | Prepare final write-up by | WT1 through 5 are |
| | | | proofing and adding necessary | automatically updated. |
| | | | information. | |
| Legal | | 24 | Ensure sufficiency and quality | WT1 through 6 are |
| review | | | of narrative to establish | automatically updated. |
| | | | statutory elements | |

Steps 1-5 Data collection and input

Situation: The raw data files have a multitude of types, names, formats, fonts, and character types including letters and numbers. Known file types are .doc, xls, .txt, .pdf, and .html. Some documents, such as monthly reports, will be named in a uniform manner that identifies the department, author, plant, and month. Some files, such as trial reports, may be named descriptively but provide no date. Others file names may be less informative and still others have almost no uniformity or function.

Goal: Method and means to store and search a vast quantity of documents that include varied file types.

Input: AIl raw technological data, employee database, write-ups from prior year

Suggested functionalities: Organize files into some type of broad categories, i.e., plant and department, the 3 major R&E types of machine-process-product. Creates a project database (WT1) for the current year and a generic write-up template with auto-fill heading block.

Steps 6-9 1^{st} Level Review—Computer

Situation: The program now stores an enormous number of files that are broadly categorized. These files must be reviewed to identify all qualified activities and expenses.

Goal: Identify all information that may relate to qualified activities and create a smaller searchable repository.

Suggested functionalities: NPL templates to extract information and load it in a single comprehensive chronological repository (WT2).

Steps 10-14 2^{nd} Level Review—Human

Situation: The WT2 repository stores a considerable amount of information that is broadly categorized. This must be reviewed to identify all qualified activities and expenses.

Goal: Identify all information that may relate to qualified activities, categorize it into associated projects, and create knowledge-based tools to enable and augment successive information gathering processes.

Low-level technical (LLT) knowledge is required to review the files and IT significantly improves the process as follows.

The LLT reviews the WT2 and highlights relevant text portions with the mouse. A right click brings up the manual IES “slice & dice” menu. This basic menu has the necessary fields to designate what should be done with the text. Suggested menu fields are project number and title, plant, activity name (the subheading), and date. When the field information is added and selected for a new project: (1) the program automatically updates the project database (WT1); (2) creates a new preliminary write-up (WT3) with the appropriate heading and adds the highlighted text to its narrative section; (3) creates a timeline (WT4) entry; and (4) an activity cost sheet (WT5).

The project database (WT1) data is used as the default for filling the menu fields according to the project number. For instance, once the project number field is filled, the project title and plant fields are filled automatically from the spreadsheet. The activity name defaults to the last subheading used but the menu has a pull down scroll to select other subheadings. Any field can be overwritten manually. This process works for any text section or entire documents. Therefore, it may be used to modify the write-ups, too. Text in an existing write-up can be highlighted and pasted to another subheading or even another write-up.

A generic write-up template consisting of a heading and all four statutory tests is used to create preliminary write-ups for each project. The LLT copies relevant information from all chronological files and pastes in the associated preliminary write-up. The information is organized: (1) according to each discrete activity with an underlined subheading; and then (2) chronologically under the subheading. The new projects are added to the project spreadsheet. A timeline is created to graphically indicate the beginning, end, and possible overlap of the various activities. In overview, this step applies technical knowledge to the raw data and produces three new tools.

Steps 15-17 Interview Process

Situation: A technically skilled person (TSP) conducts interviews for several reasons. The most enduring purpose is to collect information that is not stored in documentary format. In regard to technological information, there is usually some particular knowledge about every project that was not recorded and can only be discovered through personal interviews. The two questions become, however, Will this depth of knowledge help to identify more qualified expenses or is it necessary to explaining the qualified research activity? The interview is an overly intrusive burden on plant personnel unless the information can fulfill one of these two functions. The interviews are also conducted to identify the names of vendors, contractors, consultants, and supplies involved as well as and the names and time estimates of employees. Financial records are identified and the accounting department generates hard copy reports as required.

Most of the information mentioned above can be gathered during Step 1 by means such as a web-based repository or computer-aided collection capabilities. Some clients, however, may not want to transmit financial data in this manner. This fact, coupled with the “relationship-building” benefit of our personal presence at the plant precludes any efforts to entirely circumvent the interview process. Increasing the efficiency and reducing the burden of the interviewing process can derive the most benefit. Therefore, the three tools are used to prepare the TSP and interviewee.

Goal: Method and means to improve interview efficiency and in-plant data gathering.

Suggested functionalities: Special knowledge is required to interview personnel but IT can significantly improve the process as follows.

The TSP prepares for the interview by reviewing the information contained in WT3, WT4, and WT5. During the actual interview, the TSP has the three tools (i.e., the program) running on a lap top computer. Discussions are initiated as the appropriate preliminary write-up project and activity are on the screen. A right click on any text brings up the “interview” menu. This basic menu has the necessary fields to enter new information that is mentioned during the interview. Suggested menu fields are names of employees, contractors, consultants, vendors, supplies, expenses, and technical narrative. When the field information is added and selected for an existing project for the first time: (1) the program automatically creates a cost sheet; (2) adds the cost information to the cost sheet; (3) updates the project spreadsheet; (4) adds the narrative to the preliminary write-up; and (5) appends the cost information to the end of the selected text in the preliminary write-up. Successive additions to an existing project cause all of the above actions except (1). The cost information is appended to the text in the sense that if the text is moved to another preliminary write-up the information is also moved to the new project. Then the cost sheets and project spreadsheets will be updated automatically. In overview, this step applies a person's technical knowledge during the interview process to produce one new tool, the cost sheet, as well as adding value to the project spreadsheet and the preliminary write-ups.

Steps 18-19 Secondary Data Collection

Suggested functionalities: Any additional data input of either cost information or transcribed narrative can be input using the interview menu. When the field information is added and selected for an existing project: (1) the program adds the cost information to the cost sheet; (2) updates the project spreadsheet; (3) adds the narrative to the preliminary write-up; and (4) appends the cost information to the end of the selected text in the preliminary write-up.

Steps 21-23 Final Technical Review

Situation: Read preliminary write-ups and identify logical or technical lacunae, grammar, and spelling. Add data, information, or connecting narrative as required.

Goal: Method and means to prepare the final write-up.

Suggested functionalities: The program creates the final write-up (WT6), which will be in an acceptable format to deliver to the IRS. As changes are made the WT 1-5 are automatically updated.

Step 24 Legal Review

Situation: Read technical write-up final draft to determine if all statutory tests are met. This step may be combined with Steps 21-23 if the technical reader is an attorney.

Suggested functionalities: As changes are made the WT 1-5 are automatically updated. This software may be implemented using some or all of the technologies described above.

Option A

Digital data collection (CD only)

Manual Information Extraction System to create WT1, 3, 4, and 5

Software assisted documentation process to update WT3 and create WT6

Option B

Web enabled and digital data collection

Manual Information Extraction System to create WT1, 3, 4, and 5

Software assisted documentation process to update WT3 and create WT6

Option C

Digital data collection (CD only)

Automatic Information Extraction System to create WT1-5

Manual Information Extraction System to update WT1-5

Software assisted documentation process to update WT3 and create WT6

Option D

Web-enabled and digital data collection

Automatic Information Extraction System to create WT1-5

Manual Information Extraction System to update WT1-5

Software assisted documentation process to update WT3 and create WT6

V. Alternative Embodiments

In accordance with the provisions of the patent statutes, the principles and modes of operation of this invention have been explained and illustrated in preferred embodiments. However, it must be understood that this invention may be practiced otherwise than is specifically explained and illustrated without departing from its spirit or scope.

What is claimed is:

1. An information management system, comprising:
a depository, said depository providing for a plurality of data storage sources, a plurality of files, a plurality of source applications, and at least one interesting file, wherein each said data storage source provides for at least one said file, wherein said interesting file is one of said plurality of files, and wherein said files and said interesting file are created from said plurality of source applications;
an analysis application, said analysis application providing for a search tool, a search parameter, and a processing rule, wherein said search parameter is generated with said analysis application for said search tool in accordance with said processing rule, wherein said search tool uses said search parameter to selectively identify said interesting file from said plurality of files, and wherein said analysis application is not one of said source applications; and
a database, providing for a goal-specific record, wherein said goal-specific record includes an attribute not found within said interesting file, wherein said analysis application provides for creating said goal-specific record by retrieving information included in said interesting file in accordance with said processing rule, and transforming the retrieved information into said goal-specific record in accordance with at least one of said processing rule and said search parameter.

2. The system of claim 1, wherein said depository further provides for a plurality of storage locations, including a first storage location and a second storage location, wherein said first storage location and said second storage location each comprise at least one said data storage source.

3. The system of claim 1, wherein said depository further provides for a plurality of file types, wherein said plurality of file types include a first file type and a second file type, wherein at least one said file in said plurality of files is of said first file type, and wherein at least one said file in said plurality of files is of said second file type.

4. The system of claim 1, said depository further providing for a plurality of file types associated with said plurality of files, said plurality of file types including at least three of: an e-mail, a word processing document, a spreadsheet, a database record within said depository, a web site, a scanned document, and a text file.

5. The system of claim 1, wherein said analysis application is a tax credit application, wherein said processing rule is created from a plurality of tax rules, and wherein said goal-specific record includes a tax attribute not stored within said interesting file.

6. The system of claim 5, wherein said plurality of tax rules is entered into said tax credit application by at least one of: (a) typing in the information through a keyboard; and (b) importing data from a tax information source.

7. The system of claim 6, wherein said plurality of tax rules comprise a plurality of R&D tax rules.

8. The system of claim 7, wherein said R&D tax rules comprise a patent safe harbor tax credit rule.

9. The system of claim 1, further comprising a keyword analysis heuristic, wherein said search tool invokes said keyword analysis heuristic to identify a plurality of interesting files that exceeds the number of said interesting files that would be identified with solely said search parameter.

10. The system of claim 9, further comprising a past search result, a statistical heuristic, and a modification to said keyword analysis heuristic, wherein said analysis application generates said modification to said keyword analysis heuristic using said past search result and said statistical heuristic.

11. The system of claim 9, wherein said statistical heuristic is performed by at least one of: an artificial intelligence component, an expert system component, a predictive modeling component, or a linguistic analysis component.

12. The system of claim 1, said database providing for a plurality of goal-specific records, said analysis application providing for a report tool and a report generated by said report tool, said report tool providing for a plurality of report parameters, wherein said report tool generates said report from a selectively identified subset of interesting records, wherein said report tool selectively identifies said subset of interesting records with said plurality of report parameters.

13. The system of claim 12, wherein said report parameters do not correspond to said search parameter.

14. An information management system, comprising:
a depository, said depository providing for a plurality of data storage sources, a plurality of files, a plurality of file types, a plurality of source locations, a plurality of source applications, a plurality of organization sub-groups, and a plurality of interesting files, wherein each said data storage source provides for at least one said file, wherein said interesting files are a subset of said plurality of files, wherein said files and said interesting file are created from said plurality of source applications, wherein said plurality of interesting files include said plurality of file types, wherein said plurality of file types include an e-mail, a word processing document, a spreadsheet, and a web page, wherein said plurality of interesting files are created from said plurality of source locations, and wherein said plurality of interested files are created from said plurality of organization sub-groups;
an R&D tax analysis application, said R&D tax analysis application providing for a search tool, a plurality of search parameters, and a plurality of tax R&D tax credit processing rules, wherein said search parameter is generated with said R&D analysis application for said search tool in accordance with said R& D tax credit processing rules, wherein said search tool uses said search parameter to selectively identify said interesting files from said files, wherein said R&D tax analysis application is not one of said source applications; and
an R&D tax database, providing for a plurality of R&D tax records, wherein said R&D tax records includes a plurality of attributes not found within said interesting files, wherein said R&D tax analysis application provides for creating said R&D tax records by retrieving information included in said interesting files in accordance with said R&D tax credit processing rules, and transforming the retrieved information into said R&D tax records in accordance with said R&D tax credit processing rules and said search parameters.

15. A method for generating a plurality of tax records from a depository made up of a plurality of files that were not created for the purpose of maintaining tax information, comprising:
creating a depository of information and communications that include a plurality of files stored on a plurality of different that includes a plurality of data storage units;
installing a tax application;
configuring a plurality of tax processing rules, wherein the configuring of the plurality of tax processing rules includes defining a plurality of subject matter categories for linking information to categories of information;
performing a search of the depository using a search parameter created from a user input and at least one tax processing rule; and
populating a tax database with a plurality of tax records from information obtained from the search of the depository, wherein each tax record includes at least one attribute included in file corresponding to the tax record.

16. The method of claim 15, further comprising:
implementing a keyword analysis to expand the scope of the search parameter and the search results.

17. The method of claim 15, further comprising:
invoking a report generator with a report parameter augmented by at least one tax processing rule, submitted by the tax application to the populated database.

18. The method of claim 15, wherein populating the tax database includes invoking a pre-defined patent-safe-harbor R&D tax credit heuristic for identifying information with the various files that can be potentially relevant to establishing an R&D tax credit.

19. The method of claim 15, wherein the files in the depository originate from more than one organization unit.

20. The method of claim 15, wherein the plurality of files include e-mails, word processing documents, web pages, and spreadsheets.
